(19) United States
(12) Patent Application Publication
(10) Pub. No.: US 2015/0348103 A1
(43) Pub. Date: Dec. 3, 2015

(54) Customer Specific Retail Promotions

(71) Applicant: Michael John Parduhn, Hopkinton, MA (US)

(72) Inventor: Michael John Parduhn, Hopkinton, MA (US)

(21) Appl. No.: 14/294,285

(22) Filed: Jun. 3, 2014

(51) Int. Cl. G06Q 30/02

(52) U.S. Cl. CPC G06Q 30/0255; G06Q 30/0224

(57) ABSTRACT

A customer specific promotion system for generating individualized promotions for customers is disclosed. The system may be implemented to differentiate prices on a customer-by-customer basis. The system may include a database for storing a purchase history corresponding to a customer, a customer identification module to receive customer information associated with the customer and query the database for the purchase history based on the received customer information, a price differentiation module to generate a customer specific promotion based at least in part on the purchase history and a promotion strategy, and a promotion delivery module to communicate the customer specific promotion to the customer.

### FIELD OF THE DISCLOSURE

The disclosure relates generally to the field of retail promotions, and more particularly to a system and method for providing retail promotions specific to individual customers.

### BACKGROUND OF THE DISCLOSURE

Retailers often use coupons to attract customers and increase sales. However, coupons may not be the best tool to attract new customers, and coupons may not promote new sales. For example, many customers that would have shopped at the retailer anyway may clip these coupons. An increase in sales may therefore not be completely attributed to coupons, as the customers would have shopped at the retailer anyway. Coupons may also result in lost revenue for the retailer as the customers who would have shopped at the retailer anyhow are now receiving a discount. Additionally, many potential customers that would shop at the retailer if they had coupons do not do so if they are unaware of the coupons.

Retailers may use “rewards programs” (or similar customer identification systems) to reward customers for repeat business and to provide targeted promotions. Rewards programs, however, typically offer below-optimal prices to aggressive, repeat customers. More specifically, repeat customers are often provided with pricing below that which is necessary to retain their business. As such, the retailer may lose potential revenue. Furthermore, rewards programs typically fail to sufficiently incentivize less aggressive customers.

It is with respect to these and other considerations that the present disclosure is provided.

### SUMMARY

In view of the forgoing, systems and methods for generating and delivering customer specific retail promotions are disclosed.

An exemplary embodiment of a customer specific retail promotion system is provided. The system may include a database for storing a purchase history corresponding to a customer, and a price differentiation module to generate a customer specific promotion including an indication of a price associated with the customer specific promotion, the price differentiation module to generate the customer specific promotion and the price based at least in part on the purchase history and a range of available prices.

Another example embodiment of a customer specific retail promotion system is provided. The system may include a database for storing a purchase history corresponding to a customer, a customer identification module to receive customer information associated with the customer and query the database for the purchase history based on the received customer information, a price differentiation module to generate a customer specific promotion including an indication of a price associated with the customer specific promotion, the price differentiation module to generate the customer specific promotion based at least in part on the purchase history and a promotion strategy, and a promotion delivery module to communicate the customer specific promotion to the customer.

An example embodiment of a computer-implemented method of differential pricing is provided. The method may include receiving a purchase history corresponding to a customer from a database, receiving a plurality of available promotions, receiving a promotion strategy, generating a customer specific promotion including an indication of a price associated with the customer specific promotion based at least in part on the purchase history, the plurality of available promotions, and the promotion strategy, and communicating the customer specific promotion to a promotion terminal associated with the customer.

### BRIEF DESCRIPTION OF THE DRAWINGS

By way of example, specific embodiments of the disclosed device will now be described, with reference to the accompanying drawings, in which:

FIG. 1 is a block diagram illustrating a customer specific retail promotion system arranged in accordance with the present disclosure.

FIGS. 2-4 illustrating portions of the system shown in FIG. 1 is greater detail, all arranged in accordance with the present disclosure.

FIG. 5 is a flow diagram illustrating an exemplary computer-implemented method for differential pricing arranged in accordance with the present disclosure.

### DETAILED DESCRIPTION

Systems and methods for generating customer specific promotions and delivering such promotions to customers in accordance with the present disclosure will now be described. The systems and methods are described with reference to the accompanying drawings. In general, the disclosed systems and methods provide that retail promotions can be generated for individual customers. In particular, the present disclosure provides the ability to differentiate prices on a customer-by-customer basis. In general, individualized promotions may be generated based on a customer's buying history. With some examples, a different set of prices may be generated for each customer. These prices may be generated based on a variety of different strategies (e.g., maximize revenue, maximize number of customers, maximize sales volume, or the like). These promotions may be provided to the customer via a variety of techniques and technologies, examples of which are described herein. In some examples, the promotions may be delivered to an “app” (e.g., that may be executing on a customer smart phone, or the like). With some examples, the promotions may be communicated to displays distributed throughout the store. These displays may be configured to show the individual promotion when the customer is in the vicinity of the display.

It is important to note, however, that the disclosed systems and methods may be embodied in many different forms and should not be construed as limited to the embodiments set forth herein. Rather, these embodiments are provided so that this disclosure will be thorough and complete, and will fully convey the scope of the claims. In the drawings, like numbers refer to like elements throughout.

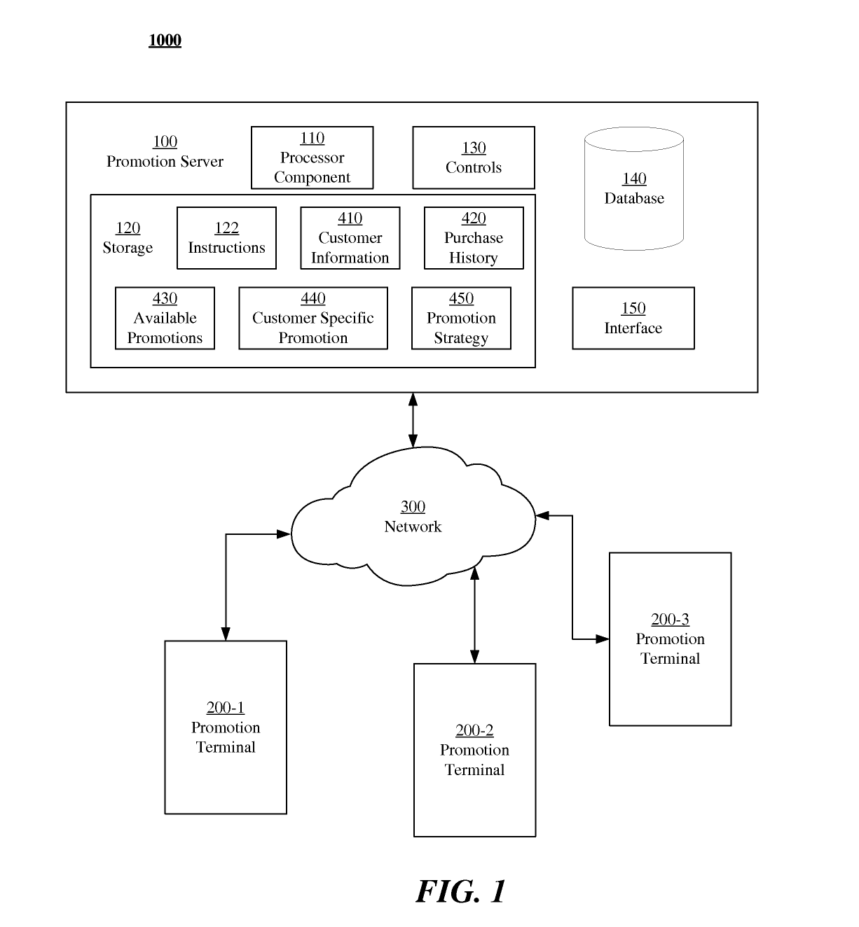

FIG. 1 is a block diagram illustrating a customer specific promotion system 1000, arranged in accordance with the present disclosure. As depicted, the customer specific promotion system 1000 may include a promotion server 100 and promotion terminals 200 operably coupled to the promotion server 100 via network 300. It is important to note, that promotion terminals 200-1, 200-2, and 200-3 are depicted. However, the system 1000 may be implemented to operate with any number of promotion terminals 200. For example, the system 1000 may include more or less promotion terminals 200 than depicted, and FIG. 1 merely depicts the number of promotion terminals 200 at a quantity to facilitate understanding.

The promotion server 100 and each of the promotion terminals 200 may be any of a variety of types of computing devices. For example, without limitation, the promotion server 100 may be a server, a desktop computer, a cloud-computing system, or the like. Each of the promotion terminals 200 may be a desktop computer, a laptop computer, a tablet, a smart phone, a kiosk, a wearable computing device, or the like. It is important to note, that with some examples, one or more of the promotion terminals 200 may be a computing device provided by the retailer. For example, one of the promotion terminals 200 may be a computer kiosk provided for use by customers in receiving customer specific promotions as described herein. With some examples, one or more of the promotion terminals 200 may be a computing devices provided by a customer (e.g., a customer owned smart phone, a customer owned wearable computing device, or the like).

As depicted, the promotion server 100 and the promotion terminals 200 exchange signals related to customer specific promotions through network 300. However, one of more of the promotion server 100 and/or the promotion terminals 200 may exchange signals unrelated to customer specific promotions with each other and/or with still other computing devices (not shown) through the network 300 or through another network (not shown).

In various examples, the network 300 may be a may be a single network possibly limited to or extending within a defined area (e.g., a retail location, or the like) or other relatively limited area, a combination of connected networks possibly extending a considerable distance, and/or may include the Internet. Thus, the network 300 may be based on any of a variety (or combination) of communications technologies by which signals may be exchanged, including without limitation, wired technologies employing electrically and/or optically conductive cabling, and wireless technologies employing radio frequency, near filed communication, infrared, or other forms of wireless transmission.

In various embodiments, the promotion server 100 incorporates one or more of a processor component 110, storage 120, controls 130, a database 140, and an interface 150 to couple the retail sales device 100 to the network 300. The storage 120 stores one or more instructions 122, customer identification 410, purchase history 420, available promotions 430, customer specific promotion 440, and/or a promotion strategy 450. It is envisioned that purchase history 420 corresponding to one or more customers, the available promotions 430, and/or the promotion strategy 450 may be stored in the database 140. However, they are shown stored in memory 120 for clarity of presentation. Furthermore, it is envisioned that during operation, the purchase history 420, the available promotions 430, and/or the promotion strategy 450 may be transferred between the database 140 and storage 120 in order to facilitate generating the customer specific promotion 440. Furthermore, although not depicted in FIG. 1, the database 140 may itself be stored in storage 120.

In the promotion server 100, the instructions 122 may correspond to a sequence of instructions operative on the processor component 110 to implement logic to perform various functions. As discussed above, the promotion server 100 is configured to communicate with multiple promotion terminals 200. In general, a customer may use one of the promotion terminals 200 to receive promotions specific to that customer. As such, the promotion server 100 may communicate with one of the promotion terminals 200 regarding customer specific promotions for a particular customer.

For example, the promotion server 100 may communicate with the promotion terminal 200-1 regarding a first customer and a first customer specific promotion for the first customer. Similarly, the promotional server 100 may communicate with the promotion terminal 200-2 regarding a second customer and a second customer specific promotion for the second customer. Additionally, the promotional server 100 may communicate with the promotion terminal 200-3 regarding a third customer and a third customer specific promotion for the third customer. Examples, however, are not limited in this context.

Furthermore, it is to be appreciated, that sometimes the promotion terminals 200 are referenced in singular form. Although care is taken to reference the promotion terminals 200 in singular form when discussing communication between the promotion server 100 and a one of the promotion terminals 200, it is to be appreciated that promotion server 100 is configured to communicate with multiple promotion terminals 200 (e.g., 200-1, 200-2, 200-3, or the like), and as such, reference to “a promotion terminal 200” and/or “the promotion terminal 200” is merely done for convenience and is not intended to single out a specific promotion terminal 200 or to limit the promotion server 100 to only communicating with a single and/or a specific one of the promotion terminals 200.

In executing the instructions 122, the processor component 110 receives customer information 410 (e.g., from the promotion terminal 200) corresponding to a customer and queries the database 140 for the purchase history 420 associated with the customer. As described in greater detail below, the purchase history 420 may include both simple and calculated metrics corresponding to the customer. For example, the purchase history 420 may include prior purchases, department memberships (e.g., beauty club, health club, or the like), and/or calculated scores related to the customers “value” to the organization.

Furthermore, in executing the instructions 122, the processor component 110 generates the customer specific promotion 440 for the customer associated with the customer identification 410. In general, the customer specific promotion 440 may be generated based on the purchase history 420, the available promotions 430, and the promotion strategy 450. Additionally, in executing the instructions 122, the processor component 110 communicates the customer specific promotion 440 to the customer (e.g., by transmitting an indication of customer specific promotion 440 to the promotion terminal 200).

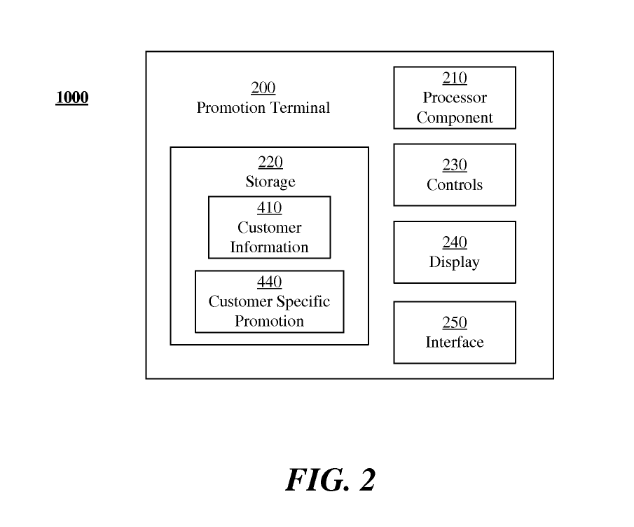

FIG. 2 illustrates a block diagram of an example promotion terminal 200, arranged in accordance with the present disclosure. It is to be appreciated, that the promotion terminal 200 depicted in FIG. 2 may correspond to one or more of the promotion terminals 200-1, 200-2, and/or 200-3. In various embodiments, the promotion terminal 200 incorporates one or more of a processor component 210, storage 220, controls 230, a display 240, and an interface 250 to couple the promotion terminal 200 to the network 300. The storage 220 stores one or more instructions 222, the customer identification 410 and the customer specific promotion 440.

In the promotion terminal 200, the instructions 222 may correspond to a sequence of instructions operative on the processor component 210 to implement logic to perform various functions. In executing the instructions 222, the processor component 210 communicates the customer information 410 to the promotional server 100. Additionally, in executing the instructions 222, the processor component 210 receives the customer specific promotion 440 from the promotional server 100. Furthermore, in executing the instructions 222, the processor component 210 provides the customer specific promotion 440 to the customer (e.g., by displaying the customer specific promotion 440 on the display 240, by sending the customer specific promotion 440 to a printer, or the like).

In various embodiments, each of the processor components 110 and/or 210 may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are in some way linked.

In various embodiments, each of the storages 120 and/or 220 may be based on any of a wide variety of information storage technologies, possibly including volatile technologies requiring the uninterrupted provision of electric power, and possibly including technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, the display 240 may be any of a variety of computer displays, such as, for example, CRT, plasma, LCD, LED, OLED, eInk, or the like.

In various embodiments, each of the interfaces 150 and/or 250 may employ any of a wide variety of signaling technologies enabling computing devices to be coupled to other devices as has been described. Each of these interfaces may include circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards.

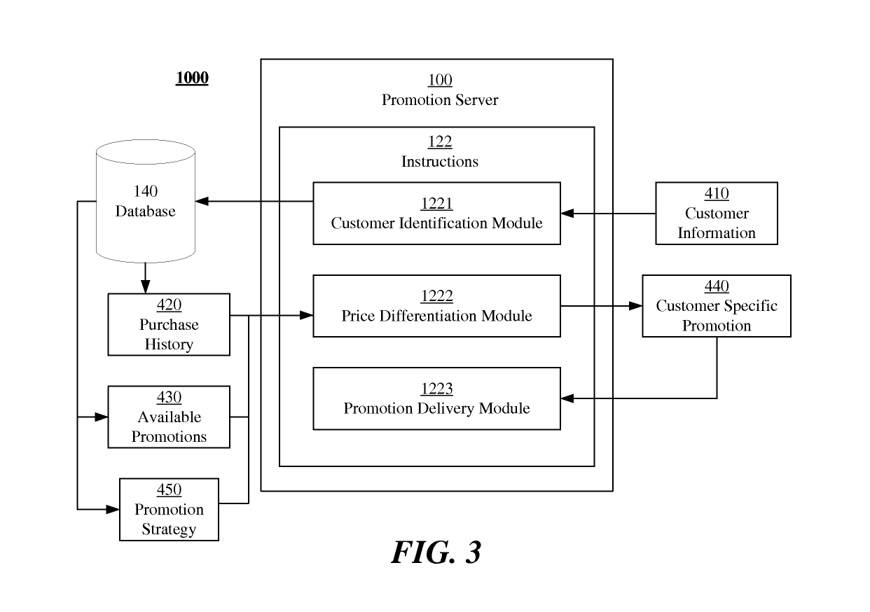

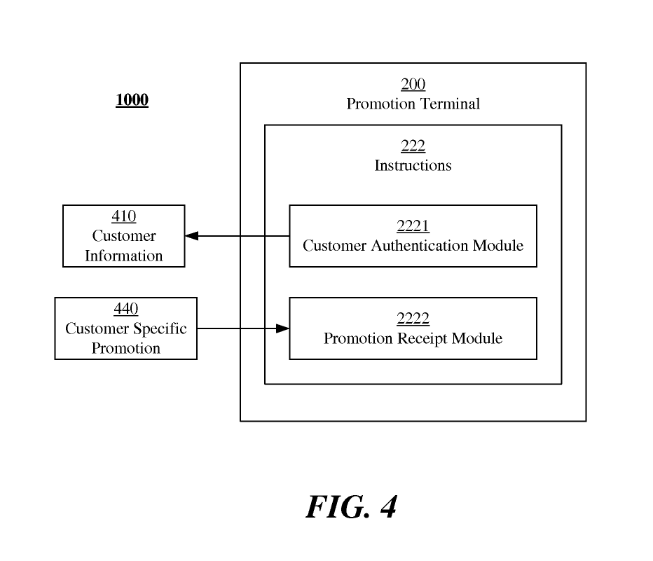

FIGS. 3-4 are each a simplified block diagram of a portion of an embodiment of the system 1000 of FIGS. 1-2. Each of these figures depicts aspects of the operation of generating customer specific retail promotions. Said differently, these figures depict aspects of the operation of generating individualized promotions for customers. In general, FIG. 3 depicts aspects of the operation of the promotion server 100 while FIG. 4 depicts aspects of the operation of the promotion terminal 200.

Turning more specifically to FIG. 3, the instructions 122 may include a customer identification module 1221, a price differentiation module 1222, and a promotion delivery module 1223. In general, the promotion server 100 receives an indication of a customer (e.g., customer information 410, or the like) and generates an individualized promotion (e.g., the customer specific promotion 440) for that particular customer. As is described herein, these promotions may be based on a particular strategy or objective (e.g., the promotion strategy 450). The generated customer specific promotion is then communicated to the customer (or more particularly, the promotion terminal 200 used by the customer).

The customer identification module 1221 may receive the customer information 410 from the promotion terminal 200. Said differently, the customer identification module 1221 may receive customer information 410 associated with a particular customer of a retailer. The customer identification module 1221 may also query the database 140 for the purchase history 420, the available promotions 430, and/or the promotion strategy 450.

In some examples, the customer information 410 may include indications of a rewards account corresponding to the customer. With some examples, the customer information 410 may include indications of a payment method (e.g., credit card, debit card, checking account, mobile payment method, or the like). In some examples, the customer information 410 may include purchase information. More particularly, the customer information 410 may include a purchase location, purchase time, item purchased, and/or purchase price, which may be used to identify a customer.

The customer identification module 1221 receives the customer information 410 and queries the database 140 to identify the customer based on the customer information 410. For example, where the customer information 410 includes an indication of a rewards account, payment method, or the like, the customer identification module 1221 may “look up” the customer in the database 140. As another example, where the customer information 410 includes purchase location, purchase time, item purchased, purchase price, or the like, the customer identification module 1221 may “look up” a likely customer in the database 140. More specifically, the customer information 410 may be used to determine a potential customer based on purchase histories 420 stored within the database 140.

With some examples, a customer may initiate the generation of the customer specific promotion 440. More specifically, a customer may use the promotion terminal 200 to “check in” with the promotion server. For example, the customer may open an “app” provided by the retailer on the promotion terminal. The customer may log into the promotion terminal (e.g., in the case of a kiosk like promotion terminal, or the like). The customer may log onto the retailers website, or the like. As such, the customer identification module 1221 may receive the customer information 410 from the promotion terminal 200 used by the customer.

In some examples, the promotion server 100 may initiate the generation of the customer specific promotion 440. This will be explained in greater detail below.

The price differentiation module 1222 may generate the customer specific promotion 440 based on the purchase history 420, the available promotions 430, and/or the promotion strategy 450. In general, the price differentiation module 1222 receives the purchase history 420 associated with the customer and generates an individualized promotion for the customer. The individualized promotion may include an item and a promotional price for the item.

With some examples, the purchase history 420 may include indications of prior purchases made by the customer and/or associated with the customer (e.g., made using the customer's reward account, or the like). In some examples, the purchase history 420 may include a listing of prior items purchased, purchase times, purchase locations, purchase prices, or the like. Additionally, the purchase history 420 may include indications of any coupons, discounts, promotions, sales, or the like, used when purchasing the items.

Additionally, the purchase history 420 may include indications of a life span of the items purchased. For example, if the items include a specific supply (e.g., 60 day supply of vitamins, 32 load laundry detergent, or the like) the life span may be determined based on the specific supply. As another example, the life span may correspond to the shelf life (e.g., a manufacturer shelf life, or the like.)

Furthermore, in some examples, the purchase history 420 may include calculated or derived information related to the customer. In further examples, the customer information may be calculated and/or derived based on the purchase history 420.

In some examples, the available promotions 430 may include manufacturer coupons, retailer promotions and/or sales, surplus stock promotions, “loss leader” promotions, or the like. For example, available promotions 430 may correspond to manufacturer, middleman, and/or freestanding insert coupons. As another example, available promotions 430 may include listings of available discounts (e.g., a specified percentage off everything not already on sale, a specified percentage off a category of products, a specified percentage off a single product of the customer's choosing, a specified percentage off any product from within a class (e.g., beauty, automotive, grocery, or the like) of products, or the like. As another example, the available promotions 430 may include combination promotions (e.g., purchase a first product and receive a discount on a second product, buy one get one free, buy two get one free, or the like).

Additionally, the available promotion 430 may include a “range of prices” that may be used in generating the customer specific promotion 440 and a price associated with the customer specific promotion 440. As noted above, various embodiments provide that prices may be differentiated on a customer-by-customer basis. As such, the range of available prices may be used to select the price to offer to each customer. For example, customers may be offered a price selected from the range of available prices based on the purchase history 420 associated with the customer.

With some examples, the promotion strategy 450 may include rules, algorithms, logic, or the like, to determine specific promotions for a customer based on the customers purchase history 420 and the available promotions 450. Additionally, the promotion strategy 450 may include one or more rules to determine the price associated with the customer specific promotion based at least in part on the range of available prices (e.g., as specified in the available promotions 430, or the like). It is to be appreciated, that an exhaustive list of all possible promotion strategies is not feasible to provide. More specifically, as the promotion strategies may vary greatly depending upon the implementation, retailer, customer demographics, or the like, a few examples are instead provided for clarity of presentation. However, these examples are in no way intended to be limiting and the promotion strategy may include any variety of “rules” for determining individualized promotions as described herein.

In some examples, the promotion strategy 450 may include indications that the promotions are to be derived based on coupons (e.g., manufacture coupons, non-manufacturer coupons, competing retailer coupons, or the like). Furthermore, the promotion strategy 450 may include indications that a customer's promotion is to be determined based on a “aggressiveness” of the customer. For example, customers who only shop with coupons (e.g., as determined by the purchase history 420) may be considered “aggressive” customers while customers who rarely shop with coupons (e.g., as determined by the purchase history 420) may be considered “casual” customers. The promotion strategy 450 may indicate that more aggressive customers are to receive less (e.g., in percent, or the like) of the manufacturer coupon.

In some examples, the promotion strategy 450 may include indications that “loss leader” type items are to be offered to a customer based on the customer's purchase history 420. For example, a loss leader type item to include in a customer specific promotion 440 may be selected from a listing of available loss leader items (e.g., as indicated in the available promotions 430) based on the customer purchasing a similar item in the past (e.g., as indicated in the purchase history 420).

With some examples, the customer information 410 may include a location corresponding to the customer 410 and/or other demographic data associated with the customer. The promotion strategy 450 may include indications that the customer specific promotion 440 is to include an item selected from a list of popular items for the customer's location and/or demographic.

With some examples, promotion strategy 450 may include one or more indications[MJP1] that the customer specific promotion 440 should be generated based on a determination that an item is of “high-value” to the customer. For example, items frequently purchased by a customer (e.g., as indicated by the purchase history 420, or the like) may be considered high-value. In some examples, items where the promotion is greater than a specified percentage, set to expire within a specified period of time, deemed desirable to the customer based on the customer's location and/or demographics, or the like may be considered high-value.

With some examples, the promotion strategy 450 may include indications that a promotion should be canceled if the item becomes and/or is out of stock at location(s) near the customer or locations where the customer has previously shopped (e.g. as indicated by the purchase history 420). With some examples, the promotion strategy 450 may include indications that when a customer purchases a first item (e.g., at a retail checkout counter, or the like) or adds the first item to a shopping cart (e.g., online shopping cart, mobile app shopping cart, or the like) a promotion for a second item may be generated. For example, if the customer purchases a toothbrush, a promotion for toothpaste may be generated.

In some examples, the promotion strategy 450 may include indications that promotions for items that the customer has recently purchased should not be generated. For example, the promotion strategy 450 may include an indication that items purchased by the customer recently (e.g., as indicated by the purchase history 420) that do not expire soon and/or whose life-span extend for a specified period of time should not be generated. For example, a customer may not be offered a particular promotion for laundry detergent if the customer recently purchased laundry detergent.

In some examples, the promotion strategy 450 may include indications that revenue is to be maximized. For example, the promotion strategy 450 may specify that customer specific promotions 440 are to be generated based on rules and/or algorithms intended to maximize store revenue. For example, items frequently purchased by a customer may not be offered in a customer specific promotion with the intent that the customer will purchase the items without a promotion. As another example, items frequently purchased by a customer using a manufacture coupon may be offered as a customer specific promotion wherein less than the full value of the manufacturer coupon is offered in the promotion.[RD2] For example, some customers may not make a purchase unless they are provided a broader (e.g., store-wide, department wide, overall price based, or the like) discount. Accordingly, the promotion strategy 450 may specify that customer specific promotions 440 including such broader based discounts are generated for some customers. In some examples, the promotion strategy may balance the cost of the customer specific promotion (e.g., additional discount, or the like) with an assumed amount of incremental sales the customer specific promotion 440 will generate.

The promotion delivery module 1223 may communicate the customer specific promotion 440 to the customer. More specifically, the promotion delivery module 1223 may communicate the customer specific promotion to the promotion terminal 200 associated with the customer (e.g., through network 300, or the like). As noted, in some examples, the customer may initiate the generation of the customer specific promotion 440. As such, the promotion delivery module 1223 may communicate the customer specific promotion 440 to the promotion terminal 200 used by the customer. In some example, the promotion server 100 may initiate the generation of the customer specific promotion. As such, the promotion delivery module 1223 may communicate the customer specific promotion to the promotion terminal 200 associated with the customer.

In some examples, the promotion delivery module 1223 may communicate the customer specific promotion 440 as an alert (e.g., smart phone app alert, tablet app alert, or the like,) an SMS message, an MMS message, an email, a social media post, a social media message, a print mailer, in store active signing or displays, on a PIN pad (e.g., at a register), or the like.

Turning more specifically to FIG. 4 the instructions 222 may include a customer authentication module 2221 and a promotion receipt module 2222. The customer authentication module 2221 may communicate the customer information 410 to the promotion server 100. As described above, the customer information 410 may include indications (e.g., rewards account, credit card information, or the like) used to identify the customer.

The promotion receipt module 2222 may receive the customer specific promotion 440 from the promotion server 100. The promotion receipt module 2222 may also cause the customer specific promotion 440 to be presented for the customer (e.g., displayed on display 240, printed to an auxiliary printer, or the like.)

In some examples, the promotion terminal 200 may be a smart phone, a tablet, or another device used by the customer and the instructions 222 may be part of an application (e.g., “app”) executing on the promotion terminal 200. The promotion receipt module 2222 may present the customer specific promotion 440 to the customer as part of a personalized shopping list. For example, the personalized shopping list may include the ability for the customer to browse, add, or delete products to or from the shopping list. Additionally, the personalized shopping list may auto-populate with items from the purchase history 420. It is important to note, that the items referenced in the shopping list may include a corresponding price. These prices may be individually generated for each customer based on the customer's purchase history 420, the available promotions 430 and the promotion strategy 450 as described herein.

As another example, the promotion terminal 200 may be an in-store kiosk, or the like. Customers may use the promotion terminal 200 to log into or otherwise identify themselves to an application executing on the promotion terminal 200. For example, the customer authentication module 2221 may facilitate a customer logging into the promotion terminal 200. The promotion receipt module 2222 may display and/or print the customer specific promotion 440. Additionally, the promotion terminal 200 may facilitate synchronizing the customer specific promotion to another promotion terminal (e.g., customer provided smart phone, tablet, or the like) using, for example, the network 300, Wi-Fi, Bluetooth, NFC, or another network.

With some embodiments, a number of promotion terminals 200 may be disposed within a retail location (e.g., store, or the like). For example, promotion terminals may be disposed in various isles or departments of a retail location. In such an example, the customer authentication module 2221 may identify a customer within a specific radius or viewing angle of the promotion terminal 200. For example, the customer authentication module 2221 may use NFC, RFID, Bluetooth, Wi-Fi triangulation, or the like to identify the customer. This may be facilitated by the customer carrying another device (e.g., smart phone, tablet, RFID chip associated with the customer, or the like.) The promotion receipt module 2222 then may cause the customer specific promotion 440 to de displayed when the customer associated with the customer specific promotion is detected to be adjacent to the promotion terminal 200. In such examples, the customer specific promotion 440 may correspond to items located near the promotion terminal 200. In some examples, the price differentiation module 1222 may generate a customer specific promotion 440 based on the customer location. For example, if a customer is about to walk out of a particular aisle or department (e.g., oral care aisle) a customer specific promotion related to the particular aisle or an adjacent aisle may be generated. The customer specific promotion may be delivered to the customer using any of the examples described herein (e.g., displayed on a mobile device, sent as an alert, SMS text message, or the like).

In some examples, the promotion terminal 200 may be a wearable computing device (e.g., glasses including a digital display and computing component, a smart watch, or the like) and/or a mobile computing device (e.g., smart phone) and the instructions 222 may be part of an “augmented reality” application executing on the promotion terminal 200. The promotion receipt module 2222 may be configured to display the customer specific promotion as part of the augmented reality. For example, instead of a standard price tag, the promotion receipt module 2222 may display a price tag including an indication of a price from the customer specific promotion 440.

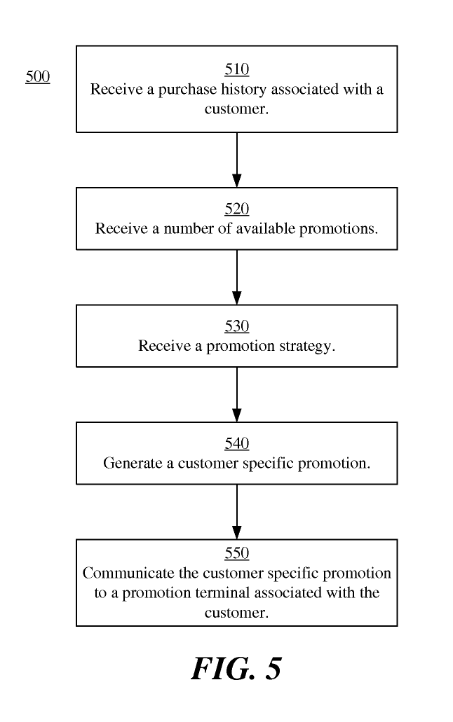

FIG. 5 is a simplified block diagram of an example logic flow 500 that may be performed by various portions of the system 1000 of FIGS. 1-4. The logic flow 500 depicts aspects of a method for generating a customer specific promotion and delivering the customer specific promotion to the customer.

The logic flow 500 may begin as bock 510. At a first block 510, receive a purchase history associated with a customer; the promotion server 100 may receive the purchase history 420 associated with the customer identified by the customer information 410. For example, at block 510, the customer identification module 1221 may query the database 140 to receive the purchase history 420.

Continuing from block 510 to block 520, receive a number of available promotions; the promotion server 100 receives the available promotions 430. For example, the customer identification module 1221 may query the database 140 for the available promotions 430.

Continuing from block 520 to block 530, receive a promotion strategy; the promotion server 100 receives the promotion strategy 450. For example, the customer identification module 1221 may query the database 140 for the promotion strategy 450.

Continuing from block 530 to block 540, generate a customer specific promotion; the promotion server 100 generates the customer specific promotion 440. For example, the price differentiation module 1222 may generate the customer specific promotion 440 based on the purchase history 420, the available promotions 430, and the promotion strategy 450. More specifically, the price differentiation module 1222 may generate the customer specific promotion 440 including an indication of a price associated with the customer specific promotion 440 based at least in part on the purchase history 420, the plurality of available promotions 430, a range of available prices as defined by the plurality of available promotions, and the promotion strategy 450.

Continuing from block 540 to block 550, communicate the customer specific promotion to a promotion terminal associated with the customer; the promotion server 100 communicates the customer specific promotion 440 to the promotion terminal 200 associated with the customer. For example, the promotion delivery module 1223 may communicate the customer specific promotion 440 to the promotion terminal 200 associated with the customer.

Thus, a customer specific promotion generation system in which individualized promotions may be generated for and presented to customers is disclosed.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The various embodiments or components described above, for example, the promotion server 100 and the promotion terminal 200 may be implemented as part of one or more computer systems. Such a computer system may include a computer, an input device, a display unit and an interface, for example, for accessing the Internet. The computer may include a microprocessor. The microprocessor may be connected to a communication bus. The computer may also include memories. The memories may include Random Access Memory (RAM) and Read Only Memory (ROM). The computer system further may include a storage device, which may be a hard disk drive or a removable storage drive such as a floppy disk drive, optical disk drive, and the like. The storage device may also be other similar means for loading computer programs or other instructions into the computer system. As used herein, the term ““module” or “software” software” includes any computer program stored in memory for execution by a computer, such memory including RAM memory, ROM memory, EPROM memory, EEPROM memory, and non-volatile RAM (NVRAM) memory. The above memory types are exemplary only, and are thus not limiting as to the types of memory usable for storage of a computer program.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A customer specific retail promotion system comprising:
a database for storing a purchase history corresponding to a customer; and
a price differentiation module to generate a customer specific promotion including an indication of a price associated with the customer specific promotion, the price differentiation module to generate the customer specific promotion and the price based at least in part on the purchase history and a range of available prices.

2. The customer specific retail promotion system of claim 1, the database to further store an indication of a manufacturer coupon, the price differentiation module to generate a customer specific promotion based at least in part on the purchase history, the range of available prices, and the indication of the manufacturer coupon.

3. The customer specific retail promotion system of claim 2, wherein the manufacturer coupon is associated with a first item, the purchase history including an indication that the customer purchased the first item using the manufacturer coupon, the price differentiation module to generate the price based at least in part on the indication that the customer purchased the first item using the manufacturer coupon.

4. The customer specific retail promotion system of claim 1, the purchase history including an indication that the customer recently purchased a first item, the price differentiation module to generate the customer specific promotion for a second item.

5. The customer specific retail promotion system of claim 4, wherein the second item is complementary to the first item.

6. The customer specific retail promotion system of claim 4, wherein the price is discounted below a first price corresponding to the second item.

7. The customer specific retail promotion system of claim 4, wherein the price is inflated above a first price corresponding to the second item.

8. The customer specific retail promotion system of claim 1, the purchase history including an indication that the customer purchased a first item having a known expiration data, the price differentiation module to generate the customer specific promotion near the known expiration date.

9. The customer specific retail promotion system of claim 1, wherein the purchase history is a first purchase history, the customer is a first customer, and the customer specific promotion is a first customer specific promotion, the price is a first price, the database further storing a second purchase history corresponding to a second customer, the price differentiation module to generate a second customer specific promotion including an indication of a price associated with the customer specific promotion, the price differentiation module to generate the customer specific promotion and the price based at least in part on the second purchase history and a range of available prices, wherein the first price and the second price are different.

10. A customer specific retail promotion system comprising:
a database for storing a purchase history corresponding to a customer;
a customer identification module to receive customer information associated with the customer and query the database for the purchase history based on the received customer information;
a price differentiation module to generate a customer specific promotion including an indication of a price associated with the customer specific promotion, the price differentiation module to generate the customer specific promotion based at least in part on the purchase history, a range of available prices, and a promotion strategy; and
a promotion delivery module to communicate the customer specific promotion to the customer.

11. The customer specific retail promotion system of claim 10, wherein the promotion strategy includes one or more rules to determine the price associated with the customer specific promotion based at least in part on the range of available prices.

12. The customer specific retail promotion system of claim 10, the promotion delivery module configured to communicate indications of a shopping list to a promotion terminal, wherein the shopping list includes the customer specific promotion.

13. The customer specific retail promotion system of claim 12, wherein the purchase history includes one or more prior purchased items and the shopping list further includes at least one of the one or more prior purchased items.

14. The customer specific retail promotion system of claim 10, the customer identification module to determine a location of the customer, wherein the price is less than a standard price, wherein an item corresponding to the customer specific promotion is overstocked at one or more retail locations within a specified distance of the location of the customer.

15. The customer specific retail promotion system of claim 10, the promotion delivery module to communicate the customer specific promotion to a promotion terminal associated with the customer.

16. The customer specific retail promotion system of claim 15, wherein the promotion terminal is one of a plurality of promotion terminals disposed within a retail location.

17. The customer specific retail promotion system of claim 15, wherein the promotion terminal is a wearable computing device.

18. A computer-implemented method for differential pricing, comprising:
receiving a purchase history corresponding to a customer from a database;
receiving a plurality of available promotions;
receiving a promotion strategy;
generating a customer specific promotion including an indication of a price associated with the customer specific promotion based at least in part on the purchase history, the plurality of available promotions, a range of available prices, and the promotion strategy; and
communicating the customer specific promotion to a promotion terminal associated with the customer.

19. The method of claim 18, wherein the promotion strategy includes one or more rules to determine the price associated with the customer specific promotion based at least in part on the range of available prices.

20. The method of claim 18, the purchase history including an indication that the customer recently purchased a first item, the price differentiation module to generate the customer specific promotion for a second item.

21. The method of claim 18, wherein the purchase history is a first purchase history, the customer is a first customer, the customer specific promotion is a first customer specific promotion, and the price is a first price, the method further comprising:
receiving a second purchase history corresponding to a second customer; and
generating a second customer specific promotion including an indication of a second price associated with the second customer specific promotion based at least in part on the second purchase history, the plurality of available promotions, and the promotion strategy, wherein the first price and the second price are different.
